(19) United States
(12) Patent Application Publication
(10) Pub. No.: US 2008/0012942 A1
(43) Pub. Date: Jan. 17, 2008

(54) Imaging System

(75) Inventors: Hiroyuki Kawamura, Tokyo (JP); Hironori Hoshino, Tokyo (JP)

Correspondence Address: JORDAN AND HAMBURG LLP, 122 EAST 42ND STREET, SUITE 4000, NEW YORK, NY, 10168, US

(73) Assignee: NILES CO., LTD., Ota-ku, Tokyo (JP)

(21) Appl. No.: 10/584,008

(22) PCT Filed: Dec. 25, 2003
(86) PCT No.: PCT/JP03/16810

§ 371 Date: Apr. 12, 2007

(51) Int. Cl. H04N 5/33; H04N 9/68

(52) U.S. Cl. 348/164; 348/234; 348/E05.09; 348/E09.053

(57) ABSTRACT

An imaging system includes an infrared lamp to emit infrared light, a CCD camera (5) to pick up an image of a place irradiated with the infrared lamp and convert the picked-up image into an electric signal, and an image processing unit (7) to periodically change a signal accumulation time of the CCD camera and periodically and continuously provide images of different exposure values. The image processing unit extracts a high-brightness block surrounded with a medium-brightness area from a first image of the periodically provided images, and according to a degree of the medium-brightness area, controls a signal accumulation time of a second image to be picked up.

### FIELD OF THE INVENTION

The present invention relates to an imaging system employing, for example, a CCD camera.

### BACKGROUND OF THE INVENTION

There is a conventional imaging system as shown in FIG. 22. In FIG. 22, the imaging system includes a CCD (charge-coupled device) 101 as an image pickup unit, a DSP (digital signal processor) 103 and a CPU (central processing unit) 105 as an image processing unit.

The CPU 105 and DSP 103 are connected to each other through a multiplexer 107. The CPU 105 receives a signal from a shutter speed setting switch 109. The switch 109 sets a shutter speed for an odd field (the oddth) and a shutter speed for an even field (the eventh).

That is, the CPU 105 reads a shutter speed set by the switch 109, encodes the read shutter speed for a given field, and provides the encoded shutter speed. The DSP 103 outputs a field pulse signal shown in FIG. 23. When the field pulse signal is high, the multiplexer 107 provides a shutter speed set terminal of the DSP 103 with a shutter speed set for an even field. When the field pulse signal is low, the multiplexer 107 provides the shutter speed set terminal of the DSP 103 with a shutter speed set for an odd field. In this way, the imaging system of FIG. 22 can set different shutter speeds depending on fields.

There is a general CCD camera employing the same shutter speed for odd and even fields. FIG. 24 shows an example of an image taken with this sort of CCD camera. The image includes a bright light source in dark surroundings. In the image, the bright light source and periphery thereof are invisible due to halation.

FIG. 24 shows an image taken by emitting infrared light forward with a IR lamp as an infrared light emitter when a vehicle is driven at night and picking up forward in the driving direction with a CCD camera in-vehicle. The bright light source shown in the image of FIG. 24 which is the headlights of an oncoming vehicle and the periphery thereof invisible due to halation. If there is a bright source in dark surroundings in the night, a CCD camera employing an overall photometry system is dominated by the dark surroundings, and therefore, calculates a long exposure time, i.e., a slow shutter speed.

The shutter speed may be fast to suppress the halation. This, however, makes the dark surroundings be darker to make them hardly visible as shown in FIG. 25.

If there is a reflective object such as a road sign of FIG. 26, a slow shutter speed will be set due to the road sign, to make the surroundings of the road sign be invisible in a similar fashion.

On the other hand, there is dual exposure control that changes a shutter speed field by field. This control alternately provides bright and dark images. A bright image (for example, an even field) may display dark parts, and the dark image (for example, an odd field) may display bright parts which may cause halation in the bright image.

Alternating bright and dark images results in displaying clear images on a monitor.

The dual exposure control that alternately provides bright and dark images (fields), however, causes flicker on a monitor.

FIG. 27 shows an imaging system disclosed in Japanese Patent Publication No. 07-97841. This imaging system has a processing unit 115 and a camera 113 including an image pickup element 111.

FIG. 28 schematically shows image processing carried out by the imaging system of FIG. 27. In FIG. 28, a through image is an image directly provided from the image pickup element 111 of the camera 113, and a memory image is an image of a preceding field stored in an image memory 117.

In FIG. 28, each odd field is set with a fast shutter speed and each even field is set with a slow shutter speed. In each odd field, a through image shows a main object which is crushed black, and in each even field, a through image shows a background that is saturated white. Each memory image is one field behind, and therefore, is crushed black or saturated white oppositely to a corresponding through image. Properly combining the through and memory images may provide appropriate output images shown in a bottom row of FIG. 28.

This related art, however, combines through and memory images by partly extracting and overlaying the through and memory images. Namely, the related art combines images of different exposure values together. Accordingly, this related art may reduce the flicker intrinsic to the dual exposure control but it causes a problem of creating unnatural boundaries in the combined through and memory images.

### DESCRIPTION OF THE INVENTION

An object of the present invention is to provide an imaging system capable of providing clear images.

The object is accomplished by an imaging system including an infrared light emitter configured to emit infrared light, an image pickup unit configured to pick up an image of a place irradiated with the infrared light and convert the picked-up image into an electric signal, and an image processing unit configured to periodically change a signal accumulation time of the image pickup unit and periodically and continuously provide images of different exposure values. The image processing unit extracts a high-brightness block surrounded with a medium-brightness area from a first image of the periodically provided images, and according to a degree of the medium-brightness area, controls a signal accumulation time of a second image thereof.

Accordingly, the infrared light emitter emits infrared light, the image pickup unit picks up an image of a place irradiated with the infrared light and converts the picked-up image into an electric signal, and the image processing unit periodically changes a signal accumulation time of the image pickup unit and periodically and continuously provides images of different exposure values.

Then, the image processing unit extracts a high-brightness block surrounded with a medium-brightness area from a first image of the periodically provided images, and according to a degree of the medium-brightness area, controls a signal accumulation time of a second image to be picked up.

With such a control, even if the image pickup unit receives strong light from, for example, the headlights of an oncoming vehicle, it can remove or suppress, in a picked up image, a gradually darkening area around a high-brightness block representative of the strong light. If there is a pedestrian or an obstacle in the vicinity of the strong light, the it can clearly pick up an image of the pedestrian or obstacle.

According to the imaging system of the present invention, the image processing unit divides the first image into high-brightness blocks, medium-brightness blocks, and low-brightness blocks, and according to the number of medium-brightness blocks around a group of high-brightness blocks, controls an image signal accumulation time of the second image.

According to the number of medium-brightness blocks around a group of high-brightness blocks, it can surely grasp a degree of the medium-brightness blocks and control an image signal accumulation time of the second image.

According to the imaging system of the present invention, the image processing unit divides the first image into a plurality of blocks, finds an average brightness value of each of the blocks, and according to the average brightness values of the blocks and two thresholds, classifies the blocks into high-brightness blocks, medium-brightness blocks, and low-brightness blocks.

Therefore, it can improve an image processing time compared with a technique that processes an image pixel by pixel.

According to the imaging system of the present invention, the image processing unit divides the first image into a plurality of blocks, classifies pixels in each of the blocks into high-brightness pixels, medium-brightness pixels, and low-brightness pixels according to two thresholds, finds a maximum one of the numbers of the high-, medium-, and low-brightness pixels in each of the blocks, determines the brightness level of the pixels of the maximum number as the brightness level of the block, and according to the determined brightness levels of the blocks, classifies the blocks into high-brightness blocks, medium-brightness blocks, and low-brightness blocks.

Therefore, it secures correctness by processing an image pixel by pixel.

According to the imaging system of the present invention, the image processing unit finds the number of medium-brightness blocks surrounding each high-brightness block, finds a maximum one of the numbers of the surrounding medium-brightness blocks, and controls an image signal accumulation time of the second image according to the maximum number.

Therefore, it can easily identify halation and speedily conduct image processing.

According to the imaging system of the present invention, the image processing unit finds the number of high-brightness blocks that form a group, the number of medium-brightness blocks around the group, and a reference number of medium-brightness blocks related to the group, and controls an image signal accumulation time of the second image according to these numbers.

Therefore, it can properly identify halation and correctly conduct image processing.

According to the imaging system of the present invention, the image processing unit identifies a high-brightness block and searches the periphery of the high-brightness block for medium-brightness blocks and high-brightness blocks, the found high-brightness blocks are grouped with the high-brightness block.

Therefore, it can correctly and speedily extract and control high-brightness blocks.

According to the imaging system of the present invention, the infrared light emitter, image pickup unit, and image processing unit are installed in a vehicle. The infrared light emitter emits infrared light toward the outer side of the vehicle. The image pickup unit picks up an image of the outer side of the vehicle.

Even if there is halation due to, for example, the headlights of an oncoming vehicle, it can remove or suppress a gradually darkening area around the halation. If there is a pedestrian or an obstacle in the vicinity of the halation, it can clearly pick up an image of the pedestrian or obstacle.

### BRIEF DESCRIPTION OF THE DRAWINGS

FIG. 1 is a general view showing a vehicle in which an imaging system according to an embodiment of the present invention is installed;

FIG. 2 is a block diagram showing an image pickup unit and an image processing unit according to the embodiment;

FIG. 3 is a flowchart according to the embodiment;

FIG. 4 is an image showing a light source in an image picked up according to simple control;

FIG. 5 is a graph showing changes in brightness along a horizontal line across the strong light source of FIG. 4;

FIG. 6 is an image showing a reflective object in an image picked up according to simple control;

FIG. 7 is a graph showing changes in brightness along a horizontal line across the large reflective object of FIG. 6;

FIG. 8 is a model showing blocks divided from brightness data of an even field according to an embodiment;

FIG. 9 is a table showing the coloring of a block based on a gray ratio according to an embodiment;

FIG. 10 is a schematic view showing the coloring of a block according to an embodiment;

FIG. 11 is a schematic view showing a block search sequence according to an embodiment;

FIG. 12 is an image showing an output image including a bright source whose periphery is to be examined;

FIG. 13 is an image showing a result of examination of the image of FIG. 12 with three colors according to an embodiment;

FIG. 14 shows relationships between the number of standard blocks and the number of white blocks according to the embodiment, in which (a) includes one white block, (b) includes two white blocks, and (c) includes three white blocks;

FIG. 15 is a schematic view showing blocks related to halation according to an embodiment;

FIG. 16 is an image showing an output image showing among reflective objects and light sources;

FIG. 17 is an image showing a result of FIG. 16 according to an embodiment;

FIG. 18 is a table showing exposure differences between even and odd fields according to an embodiment;

FIG. 19 is a view showing transition of halation strength according to an embodiment;

FIG. 20 is an image showing a processed image in which an object is visible in halation according to an embodiment;

FIG. 21 is an image showing a processed image in which surroundings are visible irrespective of reflective objects according to an embodiment;

FIG. 22 is a block diagram according to a related art;

FIG. 23 is a view showing a field pulse according to the related art;

FIG. 24 is an image showing an output image including a light source and its surroundings that are invisible due to halation according to the related art;

FIG. 25 is an image showing an output image including parts that are invisible due to halation according to the related art;

FIG. 26 is an image showing an output image including reflective objects and their surroundings that are invisible according to the related art;

FIG. 27 is a block diagram according to another related art; and

FIG. 28 is a view showing images according to another related art.

### BEST MODE FOR CARRYING OUT THE INVENTION

### First Embodiment

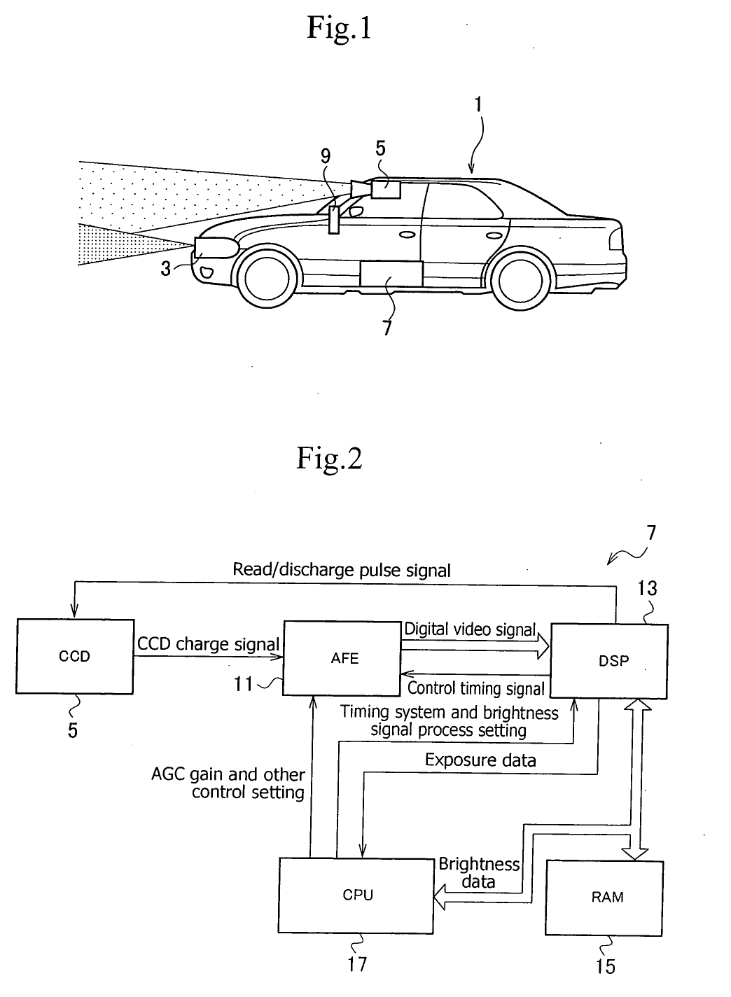

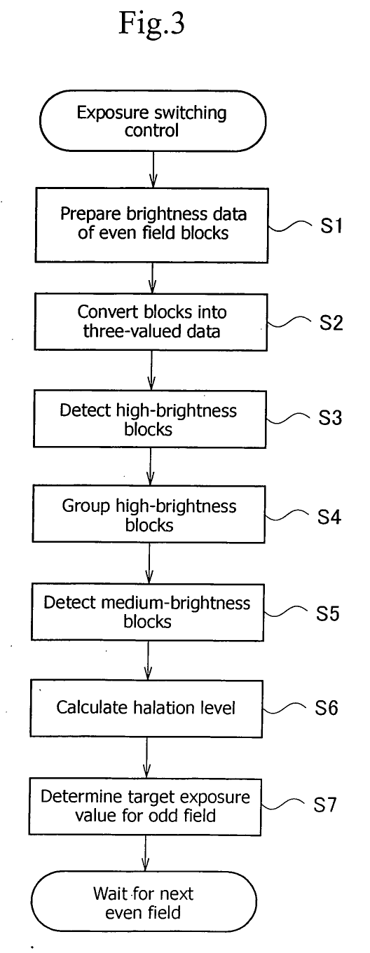

An imaging system according to an embodiment of the present invention will be explained with reference to FIGS. 1 to 21. FIG. 1 generally shows a vehicle 1 in which the imaging system according to the embodiment is installed, FIG. 2 is a block diagram showing the imaging system, and FIG. 3 is a flowchart showing exposure switching control according to the embodiment.

In FIG. 1, the vehicle 1 has an infrared lamp 3 serving as an infrared light emitter for emitting infrared light, a CCD camera 5 serving as an image pickup unit, an image processing unit 7, and a head-up display 9.

The infrared lamp 3 emits infrared light to the front side of the vehicle in a running direction of the vehicle 1 to pick up images in the night or when the circumstance of the vehicle 1 is dark. The CCD camera 5 photographs as photosensitive elements a front sight of the vehicle 1 with the infrared light emitted and converts the photographed image into an electric signal. Photodiodes in the CCD camera 5 convert images into electric signals. The image processing unit 7 changes a signal accumulation time of the CCD camera 5 at predetermined intervals, to continuously and periodically output images of different exposure values.

The signal accumulation time is set for every pixel. Changing a signal accumulation time at predetermined intervals means to change the number of pulses with which unnecessary charge accumulated in pixels is discharged. This results the change of the signal accumulation time. This operation is an electronic shutter operation. Continuously and periodically providing images of different exposure values means to set different shutter speeds for odd and even fields with the electronic shutter operation and alternately and continuously provide images of the odd and even fields at intervals of, for example, 1/60 seconds.

At a high shutter speed, bright parts are clearly picked up although dark parts are hardly picked up, and at a slow shutter speed, dark parts are clearly picked up although bright parts are saturated.

The image processing unit 7 extracts, from a first image, a high-brightness block whose periphery has a medium brightness and controls the signal accumulation time of a second image according to the degree of the medium brightness to be output continuously.

In FIG. 2, the CCD camera 5 and image processing unit 7 include a CCD 5a, an AFE 11, a DSP 13, a RAM 15, a CPU 17, and the like.

The CCD camera 5 includes the CCD 5a, the AFE 11, the DSP 13, and part of the CPU 17. The image processing unit 7 includes part of the DSP 13, the RAM 15, and the CPU 17.

The AFE 11 is an analog front end that amplifies an analog output signal from the CCD 5a and converts the amplified signal into a digital signal.

The DSP 13 is a digital signal processor that generates a timing signal for operating the CCD 5a and AFE 11 and carries out signal conversion, video signal generation, γ-conversion of a signal from the CCD 5a through the AFE 11, enhancement, digital signal amplification, and the like.

The RAM 15 is a memory to temporarily store brightness (density) data of an even field image provided by the DSP 13.

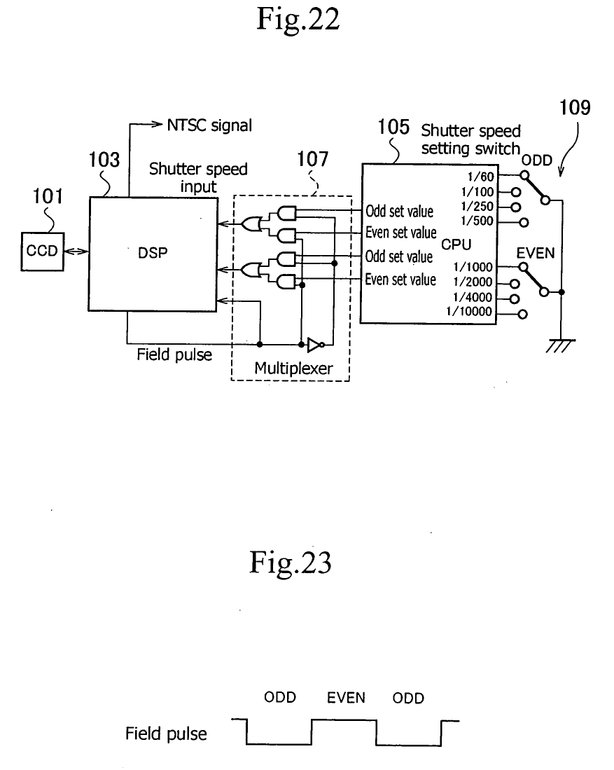

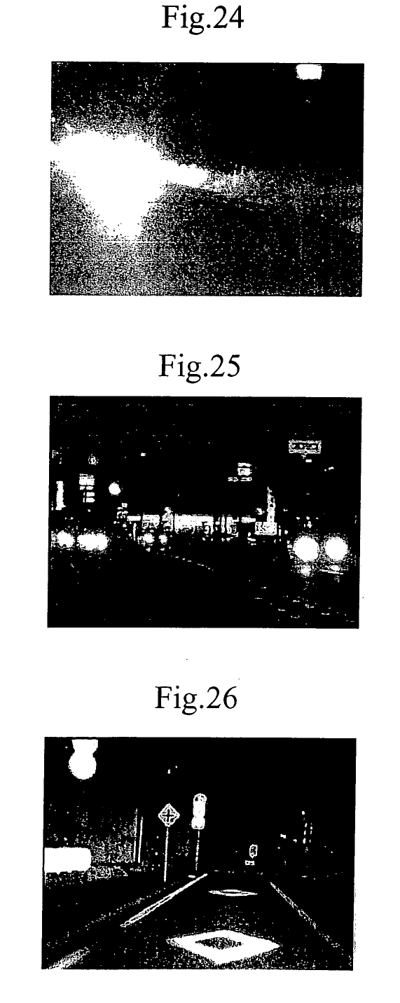

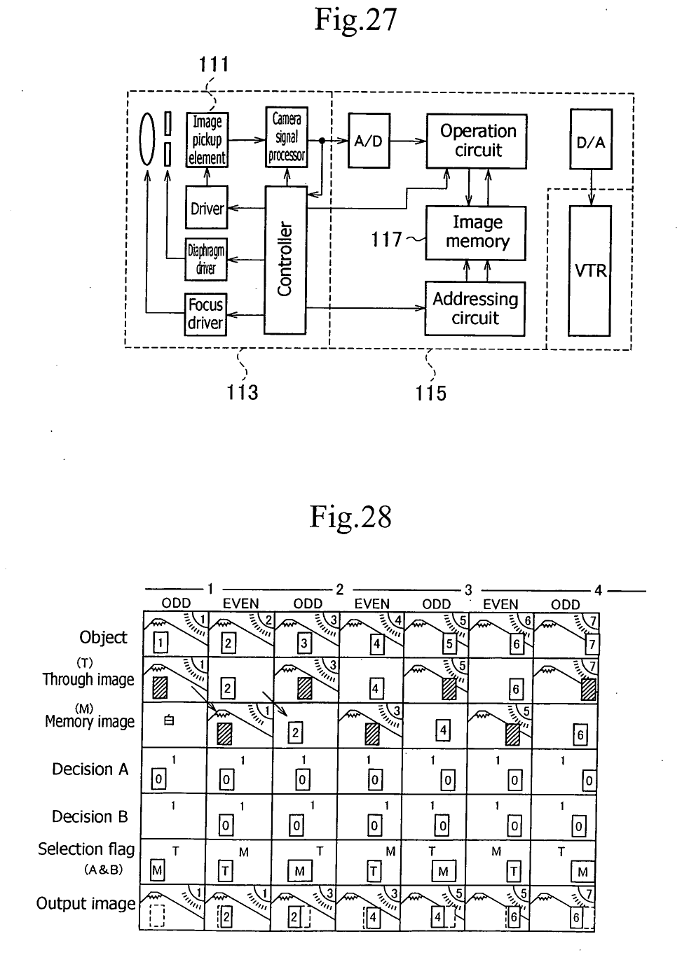

The CPU 17 carries out various operations and controls the shutter speeds of odd and even fields with the use of an arrangement such as the one explained with reference to FIG. 22. For an even field, the CPU 17 calculates an optimum exposure condition according to an average brightness of the even field, and according to the calculated condition, controls amplification of the AFE 11 and an electronic shutter operation of the CCD 5a.

Next, operation will be explained.

The CPU 17 sets initial shutter speeds and provides the DSP 13 with an odd field shutter speed control signal and an even field shutter speed control signal.

The DSP 13 generates a timing signal for operating the CCD 5a and AFE 11. Based on the timing signal, the CCD 5a picks up an image and the photodiodes of all pixels of the CCD 5a accumulate signal charge. For an odd field which is alternately arranged by the intermediary of an even field in a vertical direction, the signal charge of every odd photodiode (pixel) in a vertical direction is read at the set shutter speed. For an even field, the signal charge of every even photodiode (pixel) in the vertical direction is read at the set shutter speed.

The signal charge read in the CCD 5a is amplified by the AFE 11, is converted into a digital signal in the AFE 11, and is supplied to the DSP 13. The DSP 13 carries out signal conversion, video signal generation, y-conversion, enhancement, and digital signal amplification on the supplied signal.

Brightness data related to an even field image provided by the DSP 13 is temporarily stored in the RAM 15.

For an even field, the CPU 17 calculates an optimum exposure condition according to an average brightness, and according to the calculated condition, controls the electronic shutter of the CCD 5a through the DSP 13.

For an odd field, the CPU 17 calculates an exposure condition according to the exposure switching control shown in the flowchart of FIG. 3.

In response to starting the exposure switching control, “process of fetching brightness data of an even field block by block” is carried out in step SI. This step divides brightness data of the even field stored in the RAM 15 into blocks and calculates an average brightness of each block. Then, it forwards the process to step S2.

In step S2, “converting each piece of block data into three-valued data” is carried out. This step uses two thresholds to convert the average brightness of each block provided by step S1 into three-valued data. Then, it forwards the process to step S3.

In step S3, “detecting a high-brightness block” is carried out. This step examines the three-valued data of each block and detects high-brightness blocks in a mass. Then, it forwards the process to step S4.

In step S4, “grouping high-brightness blocks” is carried out. This step combines (groups) adjacent high-brightness blocks and finds the size of the high-brightness part (equal with the number of blocks). Then, it forwards the process to step S5.

In step S5, “detecting medium-brightness blocks” is carried out. This step finds a group of medium-brightness blocks (equal with the number of blocks) around the high-brightness block group. Then, it forwards the process to step S6.

In step S6, “calculating a halation level” is carried out. This step calculates a halation level (intensity) according to the size of the high-brightness group and the size of the medium-brightness group, or only the size of the medium-brightness group. With this calculation, it detects a maximum halation level in the even field. Then, it forwards the process to step S7.

In step S7, “determining a target exposure value for an odd field” is carried out. This step calculates degree to stop down the exposure for the odd field with respect to the even field according to the halation level of the even field. Then, the process is terminated. Thereafter, the next even field is going to be processed.

According to the exposure condition obtained as just described, the electronic shutter of the CCD 5a, an AGC gain of the AFE 11, a digital gain of the DSP 13, and the like are controlled to optimize the brightness of an image to be displayed.

The three-valued data calculation in step S2 may be based on the attribute of a majority of pixels in a given block instead of an average brightness of the block.

When the CCD camera 5 of FIG. 1 receives strong light from, for example, the headlights of an oncoming vehicle, the above-mentioned control can suppress the influence of the strong light without lowering the brightness of dark surroundings around the headlights.

A CCD camera of an imaging system generally used for a vehicle employs an interlace method as an imaging method. The interlace method employs even and odd fields that are provided alternately in terms of time to form an image having a set resolution for a viewer.

The general CCD camera calculates an exposure condition from an average brightness of light received on an even or odd field. The exposure condition determines an electronic shutter speed of a CCD, an amplification factor (AGC gain) of an AFE, and a digital amplification factor of a DSP, so that an image of optimum brightness may be generated and displayed on a monitor.

The general CCD camera applies the calculated exposure condition to each of even and odd fields, and therefore, each field provides an image of the same brightness. In the camera with just described control, when there is a strong light source (for example, the headlights of an oncoming vehicle) at night, it determines an exposure condition according to an average of overall brightness. As a result, it frequently provides the strong light source and its surroundings as saturated white objects (halation).

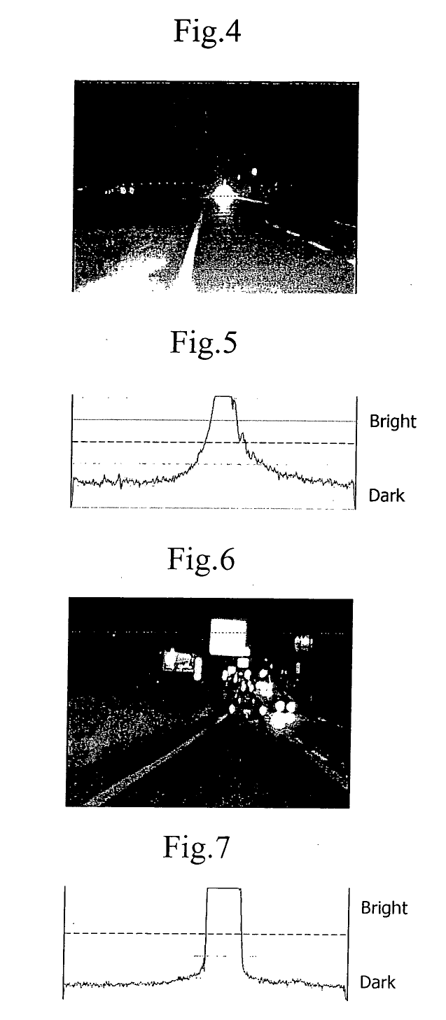

As shown in FIG. 4, a strong light source and its periphery are saturated white and the saturated part is radially scattering. Examining this in a brightness level of each pixel along a specified line (a dashed line across the strong light source of FIG. 4), it shown in FIG. 5. In FIG. 5, the strong light source and its periphery are saturated at a maximum brightness, and the brightness gradually decreases away from the strong light source.

If a pedestrian is present in the saturated area or the vicinity thereof, it is impossible for the CCD camera to catch an image of the pedestrian. Even if the center of the strong light source (headlights themselves) that is saturated white may be allowed, the periphery including the vicinity of the headlights must not be saturated so that an image of the pedestrian is picked up to be output.

In contrast, in the case of reflection that is headlight reflected by billboards, signage, signposts, road signs as shown in FIG. 6, examining a brightness level of each pixel along a specified line (a dashed line across the strong light source in FIG. 6) as mentioned above, it shown in FIG. 5. Namely, the reflective object is saturated white. However, there is no halation around the reflective object. Seeing the brightness level, the brightness curve forms steep edge. If obstacles such as pedestrians are present in the vicinity of the reflective object, an image of the pedestrians will be clearly caught. In this case, there is no need of taking a countermeasure for halation. Namely, there is no need of suppressing the exposure value of an odd field with respect to an even field. In consideration of a small light quantity from each object at night, it will be preferable to secure a sufficient exposure value for each of the even and odd fields so that an object such as a pedestrian is easily recognized.

According to the present invention, each even field is processed according to the flowchart of FIG. 3 to detect halation and find an optimum exposure condition according to new idea of the present invention, so that a dark environment at night is displayed brighter. For each odd field, the present invention sets an exposure difference according to the brightness data of the preceding even field, so that an image is displayed with a minimum influence of strong light.

By combining images of the odd and even fields having such different characteristics, the present invention displays an image in which each object is clearly visible without halation even if there are strong light sources at night, while the brightness of the periphery of the strong light is secured.

Sequential process of detecting a halation level from the brightness data of an even field, calculating an exposure condition according to the halation level, and providing the calculated result will be explained in detail.

(Dividing into Blocks)

Dividing into blocks is carried out in step S1 of FIG. 3.

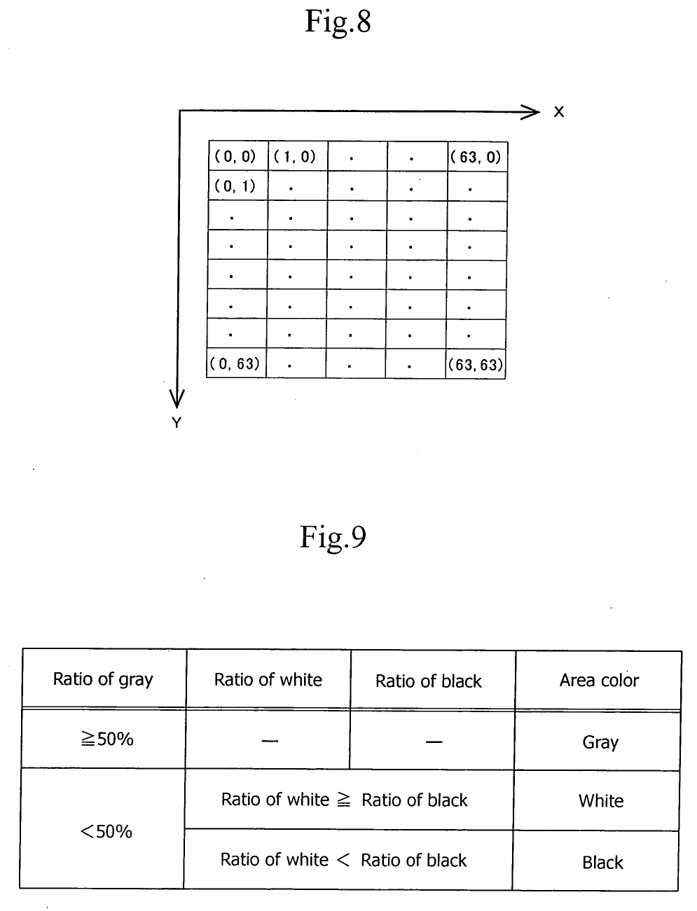

The brightness data (formed in, for example, 512 dots×240 lines) of an even field is fetched from the DSP 13 and stored in the RAM 15. The brightness data is divided into. several blocks (for example, 64×60 blocks each having 8 dots×4 lines) as shown in FIG. 8.

(Averaging the Brightness Data)

Averaging the brightness data for each block is also carried out in step SI of FIG. 3. Namely, an average of brightness values of all pixels (for example, 8×4 pixels) of each block is calculated.

(Three-Value of the Average)

The average of brightness values is three-valued in step S2 of FIG. 3. The average of brightness values is converted into three-valued data with the use of two thresholds. Each brightness value is expressed with, for example, eight bits. In this case, a minimum brightness value is 0 and a maximum brightness value is 255. There are set, for example, a white threshold of 220 (or larger), a black threshold of 150 (or smaller), and intermediate values for gray. Each block is classified into one of attributes with the white, gray, and black colors.

Namely, each block is classified as follows:

if average brightness≧white threshold, then white; or

if white value>average brightness≧black threshold, then gray; or

if average brightness<black threshold, then black.

Instead of converting the average brightness of each block into three-valued data with the use of two thresholds, each pixel of each block may be converted into three-valued data with the use of the same thresholds, the numbers of high-brightness pixels, medium-brightness pixels, and low-brightness pixels are counted, and the color of the maximum number of pixels may be assigned to the block.

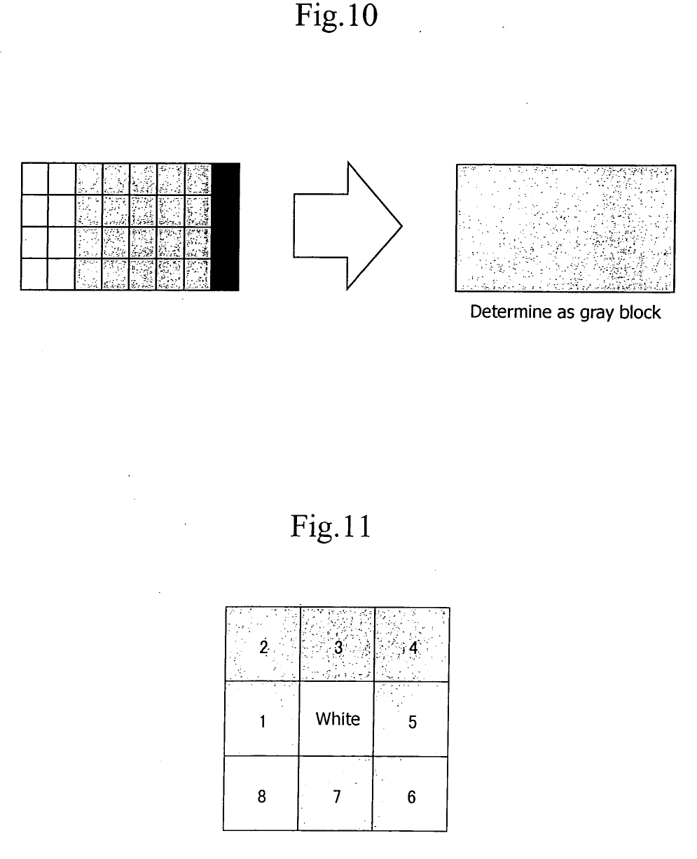

For example, each pixel in a given block is classified into one of the white, gray, and black colors on the basis of the number of the gray pixles. If the ratio of gray pixels of the block is equal to or larger than 50%, the block is classified as gray as shown in FIG. 9. If the ratio of gray pixels is less than 50%, the block is classified as white or black. In FIG. 10, the ratio of gray pixels of this block is more than 50%, and therefore, the block is classified as gray.

Instead of dividing into blocks, each pixel may be studied to detect halation and calculate an exposure value.

(Grouping Process)

On the basis of the attribute of three-valued data, a grouping process is carried out in steps S2, S3 and S4 of FIG. 3. The grouping process finds white blocks (with white attribute) in a mass.

In FIG. 8, the blocks are examined from the first block (0, 0) up to the last block (63, 0) to find a white block from a first line one after another rightward (plus direction of x coordinate). If there is no white block, it is forwarded to a second line. In this way, finding white block is carried out in turn.

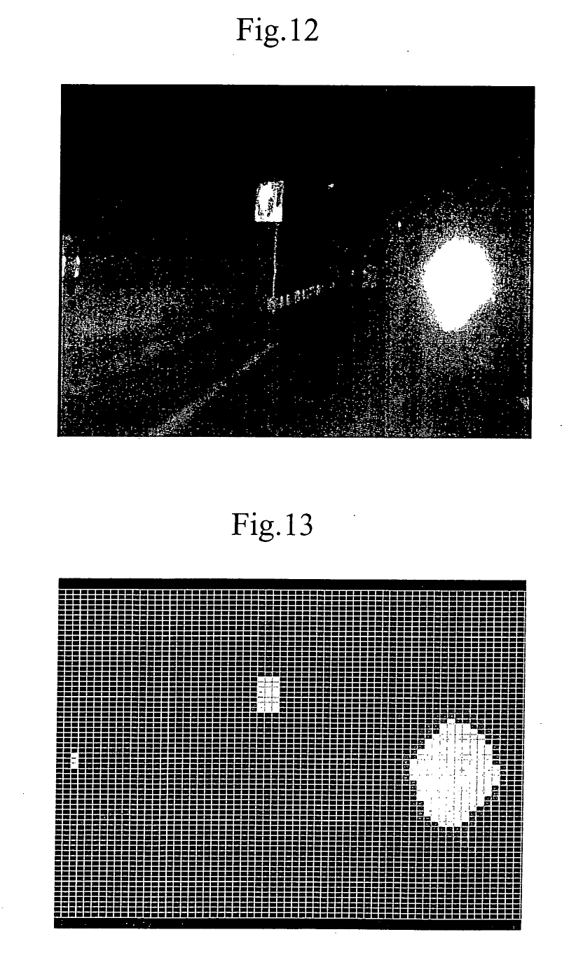

If a white block is found, surrounding eight blocks of the found white block are checked to see if there is a white block in the surrounding eight blocks in a clockwise direction in turn, as shown in FIG. 11. Found white blocks are successively chained to define a group of white blocks (peripheral detection).

For instance, FIG. 12 shows an output image including a strong light source whose periphery to be examined and FIG. 13 is a processed image showing the peripheral detection with three colors. The strong light source of FIG. 12 is from headlights. In FIG. 13, the strong light source is surrounded with continuous gray blocks. Inside the gray-block periphery, there are only white blocks, which form a group.

(Halation Detection)

Halation is detected in step S5 of FIG. 3. Halation involves a saturated center due to strong light and a periphery that gradually darkens. The center of halation is a group of white blocks and the periphery thereof is defined with gray blocks on the basis of the three-valued block.

Then, gray blocks [around] adjacent to the periphery of a group of white blocks are found, and the number of the gray blocks is counted.

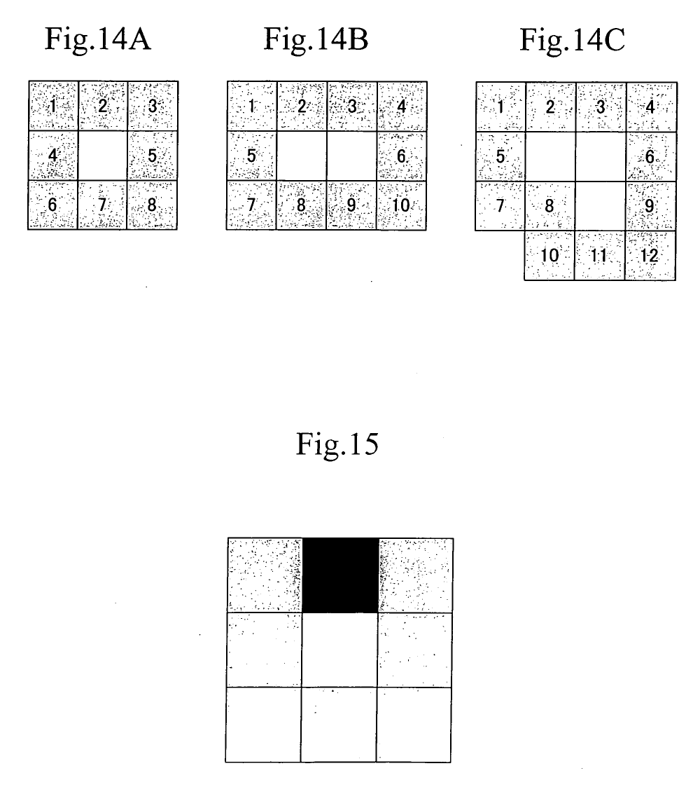

In the ideal (logical), a white-block group is surrounded with gray blocks as shown in FIG. 14. For example, in the case that a white-block group is composed of one white block, the number of gray blocks is eight, in the case that the number of white block is two, the number of gray blocks is ten, and in the case that the number of white blocks is three, the number of gray blocks is twelve. These numbers of gray blocks serve as reference block numbers when calculating a halation level according to the below-mentioned second calculation method.

(Halation Level)

A halation level is calculated in step S6 of FIG. 3 The halation level (halation intensity) in an image plan is calculated according to the detected white-block group and the gray blocks in the periphery thereof.

As methods: there are two methods that

1. A method of calculating a halation level to find, among white-block groups, a white-block group surrounded with a maximum number of gray blocks and determine this maximum number as the halation level; and

2. A method of calculating a halation level to examine the size of a given white-block group and a halation probability of the group.

The “first method” calculating a halation level to find, among white-block groups, a white-block group surrounded with a maximum number of gray blocks and determine this maximum number as the halation level

The halation detection is carried out such that the number of gray blocks around each white-block group (representative of a light source) is counted. Among the counted numbers of gray blocks, a maximum one is chosen as a halation level.

Halation level=the number of gray adjacent to white (maximum of numbers of gray blocks on one image)

As shown in FIG. 15, if a white block is detected in one block, it checks all the blocks adjacent to detected white block and determines that a halation level is seven.

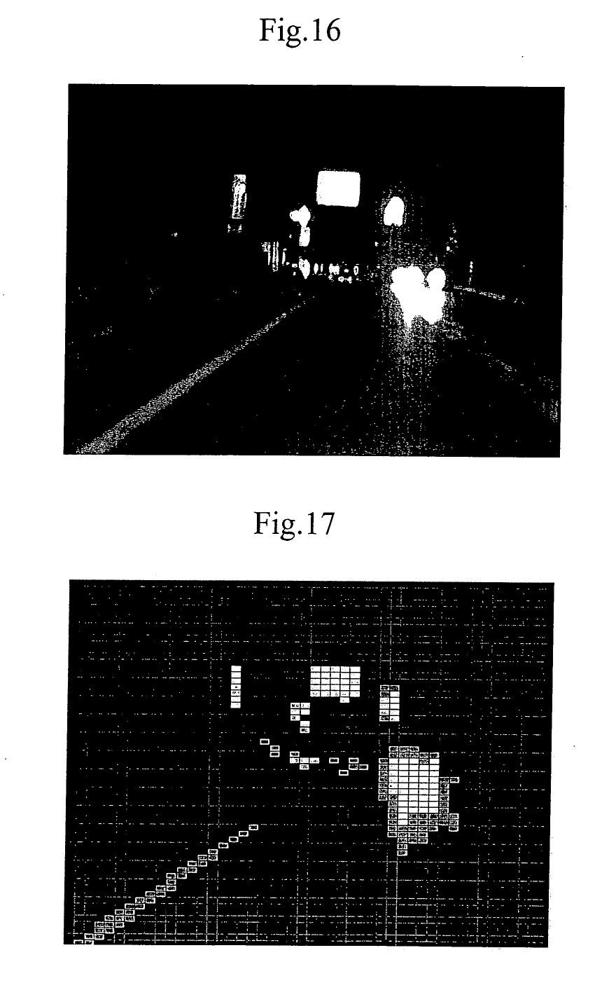

FIG. 16 shows an original image including reflective objects and a light source with halation. FIG. 17 shows a processed image composed of blocks with three-valued data made from the image of FIG. 16. As shown in FIG. 17, in the case that the image includes many white blocks and white-block groups, each periphery of the white blocks and white-block groups is examined, and a maximum one of the numbers of gray blocks is chosen as a halation level.

(Retrieved Result)

According to the examination result of the first method, the image of an example of FIG. 17 is analyzed as follows:

the number of gray blocks around a large billboard (at an upper center part of the image) is 0;

the number of gray blocks around a small billboard (at a left part of the image) is 0;

the number of gray blocks around the taillights of a front vehicle (at a central part of the image) is 2;

the number of gray blocks around a streetlight (at an upper right part of the image) is 4; and

the number of gray blocks around the headlights of an oncoming vehicle (at a lower right part of the image) is 32.

According to FIG. 17, the number of the gray blocks surrounding the maximum group of the white block at the lower right part is a maximum. This number of the gray blocks is determined as a halation level that represents a halation scale.

For instance, since the number of the gray blocks surrounding the headlights of the oncoming vehicle on this side is 32 in the above-mentioned case, a halation level is 32.”

“The second method” of calculating a halation level according to the size and probability of a white-block group

The number of gray blocks around a given white-block group is actually counted. The number of white blocks in the white-block group is counted, and according to this number, a reference number (of gray blocks of FIG. 14) is found. According to the relationship between the actual number of gray blocks and the reference number of gray blocks, a halation probability of the white-block group is calculated. A halation probability of one white-block group is calculated as follows:

Halation probability (%)=

(actual number of gray blocks/reference number of gray blocks)×100

The halation probability is multiplied by the scale of the white-block group (equal with the number of white blocks of the white-block group) to provide a halation level of the white-block group.

The image of an example of FIG. 17 is analyzed as follows:

halation level of the large billboard just about center of the upper stage) is

(0/26)×100×21=0

halation level of the small billboard at left (just about left extremity of the upper stage) is

(0/26)×100×7=0

halation level of the taillights of the oncoming car on the ahead side in the center is

(2/8)×100×1=25

halation level of the streetlight at right (right extremity of the upper stage) is

(4/18)×100×8=178

halation level of the headlights of the oncoming car on this side (right extremity of the lower stage) is

(32/37)×100×43=3718

Maximum one of the calculated halation levels of the white-block group is chosen as a halation level of the image.

Namely, since the halation level around the headlights of the oncoming car on this side is the maximum, the halation level is “3718”.

(Calculating Exposure Condition)

An exposure condition is determined in step S7 of FIG. 3.

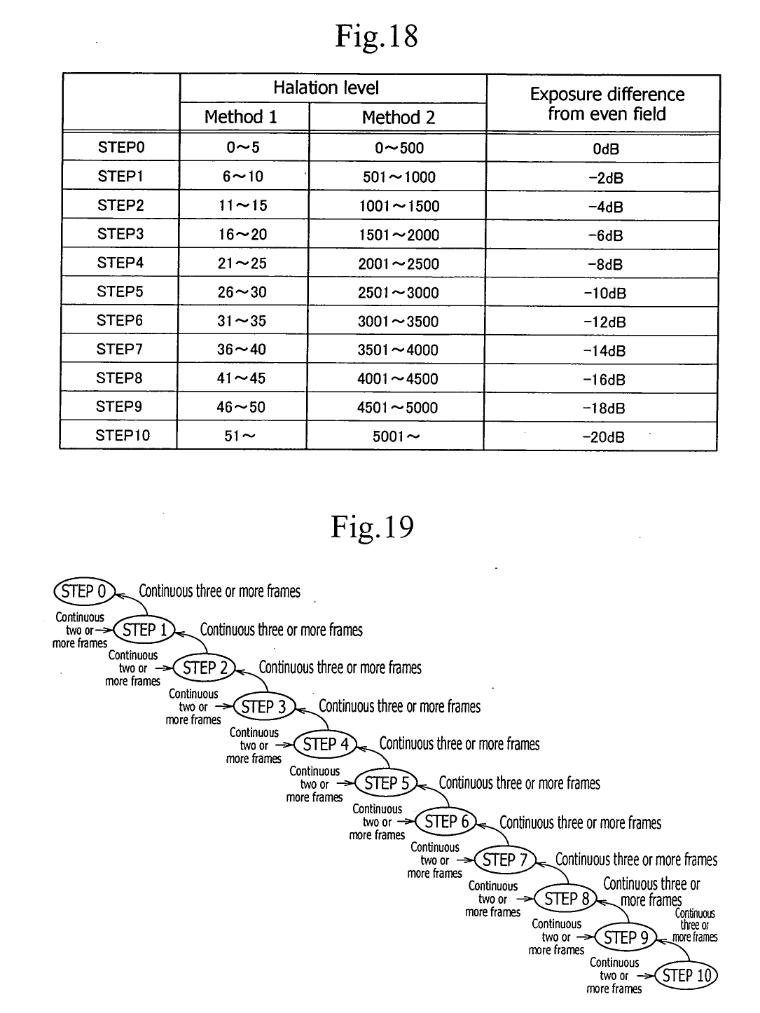

According to the halation level of the even field determined as mentioned above, an exposure difference between the even field and an odd field is found in a table shown in FIG. 18 for example. According to the exposure difference, an exposure condition for the odd field is determined to suppress the halation.

If the halation level obtained according to above-mentioned first method is in the range of 0 to 5 of STEP0, the exposure difference is 0 dB, and if the halation level is in the range of 31 to 35 of STEP6, the exposure difference is −12 dB. If the halation level obtained according to above-mentioned second method is in the range of 0 to 500 of STEP0, the exposure difference is 0 dB, and if the halation level is in the range of 3001 to 3500 of STEP6, the exposure difference is −12 dB.

If the halation level is in the range of STEP0, there is no exposure difference between the even and odd fields. If the halation level is in the range of STEP6, an exposure value for the odd field is set to be 12 dB smaller than the exposure value of the even field.

In this way, the halation level of a given even field is classified into one of STEP0 to STEP10, and the exposure value of a corresponding odd field is decreased by the value shown in a corresponding rightmost column.

As mentioned above, the present invention carries out dual exposure control according to a halation level, so that, even when there is a strong light source such as the headlights of an oncoming vehicle at night as a dark environment, dark parts may be seen brighter and excessively bright parts may be seen darker without halation.

In practice, an unpleasant feeling due to a brightness change between images on the display must be minimized. For this, the dual exposure control is quickly carried out if there is a strong light source, and if the strong light becomes weaker, odd fields are gradually made brighter, as shown in FIG. 19.

For example, if the vehicle encounters strong light of the headlights of an oncoming vehicle at a corner, the dual exposure control depending on a halation level is immediately carried out. When the oncoming vehicle passes by, the halation level will drop to the range of STEP0. If the dual exposure control immediately follows the exposure range of STEP0, the halation level of an image will abruptly change to give the driver an unpleasant feeling.

To avoid this, when light entering the CCD camera 5 becomes weaker, images in odd fields are gradually made brighter to minimize, suppress, or remove such an unpleasant feeling.

The vehicle turns a corner and suddenly meets an oncoming vehicle whose headlights provide a halation level in the range of STEP6. If this halation level continues for at least two frames of even fields as shown in FIG. 19, an exposure value for an odd field is immediately controlled according to the control of STEP6. When the oncoming vehicle passes by, the halation weakens. If a halation level below the halation range of STEP6 continues for at least three frames it switches to the control of STEP5. Thereafter, if a halation level below the halation range of STEP5 continues for at least three frames it switches to the control of STEP4. In this way, the control is gradually changed up to the control of STEP0, to thereby gradually increase the brightness of odd fields. As a result, the driver of the vehicle 1 may sense no unpleasant feeling.

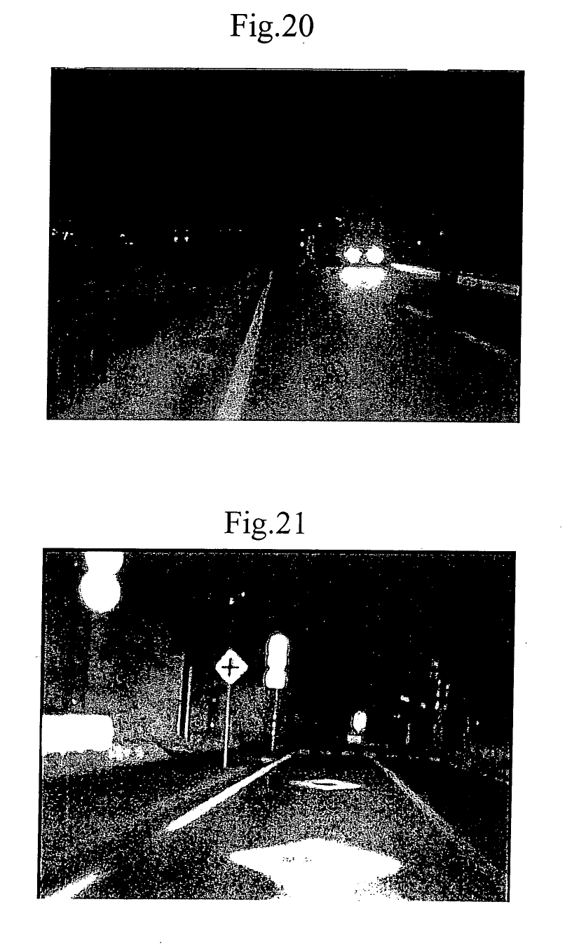

In this way, the imaging system according to the embodiment can control to change exposure control depending on direct light and reflective light. Even if it directly receives strong light from, for example, headlights, the imaging system can remove or suppress halation that includes a central saturated white area and a gradually darkening periphery as shown in FIG. 20. Even if there is a pedestrian or an obstacle around the halation, the imaging system can clearly catch an image of the pedestrian or obstacle, [as shown in FIG. 20].

In the case such that the headlights of the vehicle irradiates a billboard, the reflective object as itself is saturated white as shown in FIG. 21. In this case, only the reflective object may be saturated white and substantially no halation occurs around the reflective object. Namely, a brightness curve of the reflective object shows a sharp fall on each edge of a peak in the brightness data. Accordingly, a pedestrian or an obstacle in the vicinity of the reflective object can be clearly caught in a picked up image. In this case, there is no need of changing exposure between even and odd fields. Rather, it is necessary to secure sufficient exposure for even and odd fields in view of small light quantity to clearly catch objects at night.

The imaging system according to the embodiment is capable of reducing halation caused by strong light sources such as the headlights of an oncoming vehicle, to clearly display obstacles and pedestrians that may be present in the vicinity of the halation. For reflection from billboard, signposts, road signs, and the like, the embodiment can secure sufficient exposure to provide bright images.

The image processing unit 7 according to the embodiment divides an even field image into high-brightness white blocks, medium-brightness gray blocks, and low-brightness black blocks by three-valued process, and according to the number of gray blocks around a group of white blocks of the even field, controls the exposure of an odd field.

Based on the number of gray blocks around a white-block group of an even field, it grasps the gray block level accurately and properly controls the exposure of an odd field periodically provided.

The image processing unit 7 may divide an even field of an image into a plurality of blocks, calculate an average brightness of each block, and classify the blocks with the use of two brightness thresholds to be three-valued.

This technique is speedier than the case focusing attention on each pixel to perform three-valued process.

The image processing unit 7 may divide an even field into a plurality of blocks, classify pixels of each block into white, gray, and black pixels with the use of two thresholds, and choose a maximum one of the numbers of white, gray, and black pixels as the color of the block.

This technique processes pixel by pixel, and therefore, provides an accurate result.

The image processing unit 7 may control an image signal accumulation time of an odd field according to the maximum number of gray blocks around a white-block group.

This technique can easily identify halation and speedily process.

The image processing unit 7 may control an image signal accumulation time of each odd field according to the number of white blocks in a white-block group, the number of gray blocks around the white-block group, and a reference number of gray blocks corresponding to the white-block group.

This technique can correctly identify a halation and properly process.

The image processing unit 7 identifies a white block and then finds gray blocks around the white block in turn. If found another white block, the image processing unit 7 can add it to the preceding white block as well as identifying the gray blocks around the white block.

This technique can correctly and speedily extract a group of white blocks and process it.

The imaging system according to the invention includes the infrared lamp 3, CCD camera 5, and image processing unit 7 that are installed in a vehicle. The infrared lamp 3 emits infrared light to the front side of the vehicle, and the CCD camera 5 picks up an image of the front side of the vehicle.

Therefore, even if the halation is caused due to the headlights of an oncoming vehicle, it can remove or suppress areas around the strong lights having high brightness that gradually change to low brightness. Even if a pedestrian or an obstacle is present in the vicinity of the halation, the imaging system can clearly catch an image of the pedestrian or the obstacle.

A relationship between even and odd fields may be reversed. Namely, it is possible to find out a halation level in an odd field, and according to the halation level, find an exposure difference between the odd field and an even field, to suppress exposure of the even field.

The DSP 13 may read the charge of odd and even fields pixel by pixel, or group by group of pixels.

The above-mentioned embodiment displays an output image on the head-up display 9. Instead, the image may be displayed on a monitor installed inside the vehicle. The infrared lamp 3 irradiates the front side of the vehicle 1. Instead, the infrared lamp 3 may irradiate the rear or the side of the vehicle, so that the CCD camera may pick up an image of the rear or the side of the vehicle.

The imaging system according to the embodiment is applicable to vehicles, two-wheelers, vessels, and the like. The imaging system according to the embodiment can be used as a stand-alone system.

### POSSIBILITY OF INDUSTRIAL UTILIZATION

As mentioned above, the imaging system according to the present invention emits infrared light to the front side of a vehicle running at night, picks up an image of the front side of the vehicle with a CCD camera installed in the vehicle, and grasps the state of the front side of the vehicle.

1. An imaging system comprising:
an infrared light emitter configured to emit infrared light;
an image pickup unit configured to pick up an image of a place irradiated with the infrared light and convert the picked-up image into an electric signal; and
an image processing unit configured to periodically change a signal accumulation time of the image pickup unit and periodically and continuously provide images of different exposure values,
the image processing unit extracting a high-brightness block surrounded with a medium-brightness area from a first image of the periodically provided images, and according to a degree of the medium-brightness area, controlling a signal accumulation time of a second image to be picked up.

2. The imaging system of claim 1, wherein:
the image processing unit divides the first image into high-brightness blocks, medium-brightness blocks, and low-brightness blocks, and according to the number of medium-brightness blocks around a group of high-brightness blocks, controls an image signal accumulation time of the second image.

3. The imaging system of claim 2, wherein:
the image processing unit divides the first image into a plurality of blocks, finds an average brightness value of each of the blocks, and according to the average brightness values of the blocks and two thresholds, classifies the blocks into high-brightness blocks, medium-brightness blocks, and low-brightness blocks.

4. The imaging system of claim 2, wherein:
the image processing unit divides the first image into a plurality of blocks, classifies pixels in each of the blocks into high-brightness pixels, medium-brightness pixels, and low-brightness pixels according to two thresholds, finds a maximum one of the numbers of the high-, medium-, and low-brightness pixels in each of the blocks, determines the brightness level of the pixels of the maximum number as the brightness level of the block, and according to the determined brightness levels of the blocks, classifies the blocks into high-brightness blocks, medium-brightness blocks, and low-brightness blocks.

5.-8. (canceled)

9. The imaging system of claim 2, wherein:
the image processing unit finds the number of medium-brightness blocks surrounding each high-brightness block, finds a maximum one of the numbers of the surrounding medium-brightness blocks, and controls an image signal accumulation time of the second image according to the maximum number.

10. The imaging system of claim 3, wherein:
the image processing unit finds the number of medium-brightness blocks surrounding each high-brightness block, finds a maximum one of the numbers of the surrounding medium-brightness blocks, and controls an image signal accumulation time of the second image according to the maximum number.

11. The imaging system of claim 4, wherein:
the image processing unit finds the number of medium-brightness blocks surrounding each high-brightness block, finds a maximum one of the numbers of the surrounding medium-brightness blocks, and controls an image signal accumulation time of the second image according to the maximum number.

12. The imaging system of claim 2, wherein:
the image processing unit finds the number of high-brightness blocks that form a group, the number of medium-brightness blocks around the group, and a reference number of medium-brightness blocks related to the group, and controls an image signal accumulation time of the second image according to these numbers.

13. The imaging system of claim 3, wherein:
the image processing unit finds the number of high-brightness blocks that form a group, the number of medium-brightness blocks around the group, and a reference number of medium-brightness blocks related to the group, and controls an image signal accumulation time of the second image according to these numbers.

14. The imaging system of claim 4, wherein:
the image processing unit finds the number of high-brightness blocks that form a group, the number of medium-brightness blocks around the group, and a reference number of medium-brightness blocks related to the group, and controls an image signal accumulation time of the second image according to these numbers.

15. The imaging system of claim 9, wherein:
the image processing unit identifies a high-brightness block and searches the periphery of the high-brightness block for medium-brightness blocks and high-brightness blocks, the found high-brightness blocks being grouped with the high-brightness block.

16. The imaging system of claim 10, wherein:
the image processing unit identifies a high-brightness block and searches the periphery of the high-brightness block for medium-brightness blocks and high-brightness blocks, the found high-brightness blocks being grouped with the high-brightness block.

17. The imaging system of claim 11, wherein:
the image processing unit identifies a high-brightness block and searches the periphery of the high-brightness block for medium-brightness blocks and high-brightness blocks, the found high-brightness blocks being grouped with the high-brightness block.

18. The imaging system of claim 12, wherein:
the image processing unit identifies a high-brightness block and searches the periphery of the high-brightness block for medium-brightness blocks and high-brightness blocks, the found high-brightness blocks being grouped with the high-brightness block.

19. The imaging system of claim 13, wherein:
the image processing unit identifies a high-brightness block and searches the periphery of the high-brightness block for medium-brightness blocks and high-brightness blocks, the found high-brightness blocks being grouped with the high-brightness block.

20. The imaging system of claim 14, wherein:
the image processing unit identifies a high-brightness block and searches the periphery of the high-brightness block for medium-brightness blocks and high-brightness blocks, the found high-brightness blocks being grouped with the high-brightness block.

21. The imaging system of claim 1, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

22. The imaging system of claim 2, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

23. The imaging system of claim 3, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

24. The imaging system of claim 4, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle,

25. The imaging system of claim 9, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

26. The imaging system of claim 10, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

27. The imaging system of claim 11, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

28. The imaging system of claim 12, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

29. The imaging system of claim 13, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

30. The imaging system of claim 14, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

31. The imaging system of claim 15, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle,

32. The imaging system of claim 16, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

33. The imaging system of claim 17, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

34. The imaging system of claim 18, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.

35. The imaging system of claim 19, wherein:
the infrared light emitter, image pickup unit, and image processing unit are installed in a vehicle;
the infrared light emitter emits infrared light toward the outer side of the vehicle;
the image pickup unit picks up an image of the outer side of the vehicle.

36. The imaging system of claim 20, wherein:
the infrared light emitter, image pickup unit, and image processing unit are installed in a vehicle;
the infrared light emitter emits infrared light toward the outer side of the vehicle; and
the image pickup unit picks up an image of the outer side of the vehicle.
